(19) United States
(12) Patent Application Publication
(10) Pub. No.: US 2006/0049701 A1
(43) Pub. Date: Mar. 9, 2006

(54) Linear actuator

(75) Inventor: Shuji Sato, Tokyo (JP)

Correspondence Address: Richard P. Berg, Esq.;c/o LADAS & PARRY, Suite 2100, 5670 Wilshire Boulevard, Los Angeles, CA, 90036-5679, US

(73) Assignee: NIPPON PULSE MOTOR CO., LTD.

(21) Appl. No.: 11/221,040

(22) Filed: Sep. 6, 2005

(30) Foreign Application Priority Data
Sep. 7, 2004 (JP) 2004-259491

(51) Int. Cl. H02K 41/00

(52) U.S. Cl. 310/14; 310/12

(57) ABSTRACT

The present invention is directed to provide a linear actuator capable of propagating magnetic force of a stator magnet within a yoke in a smooth manner so as to form a superior magnetic path. A linear actuator is provided with a moveable part facing a stator magnet provided together with a coil within a yoke, with both magnetic pole pieces of the yoke being exited to an S pole and an N pole respectively by switching of energizing of the coil so as to subject the moveable part to thrust and bring about reciprocal driving. According to the present invention, the coil is divided into split coils so as to retain excitation function, and a magnetic path body for connecting the stator magnet and the yoke is provided between the split coils. Magnetic force of the stator magnet is transmitted to the yoke via the magnetic path body.

### TECHNICAL FIELD

The present invention relates to an electromagnetic linear actuator, and particularly relates to a linear actuator capable of forming a superior magnetic path within a yoke.

### BACKGROUND ART

Typically, this type of linear actuator is used in order to cause a piston of an air compressor or a blade of a razor to continuously oscillate. These oscillations correspond to oscillation drag caused by use and it is necessary to exert a strong reciprocal driving force on a moveable part so as to cause movement.

In the related art, as disclosed in U.S. Pat. No. 6,028,499, a coil and a stator magnet (permanent magnet) are arranged at the center of a yoke substantially concave in cross-section. This stator magnet and a moveable part of substantially the same width are fitted within a yoke. Inclined magnetic gaps of respective widths of 1 mm are formed between the pole pieces of the yoke, so as to bring about continuous oscillation with a short stroke of 2 mm in an axial direction.

As shown in views showing the theory of operation in FIG. 4A to FIG. 4C, by having a stator M constructed from a permanent magnet, changing poles between magnetic pole pieces Y1 and Y2 on the side of the yoke can be carried out reliably and there is the advantage that the direction of movement of the moveable part K can be decided. However, as a magnetic path from the stator magnet M to the yoke Y constituting the main route is formed via a coil, due to high magnetic resistance of the coil C on this structure, and the propagation of magnetic force from the stator magnet M to magnetic pole piece Y1 is therefore weak. Further, magnetic force from the stator magnet M to the yoke Y is dispersed and propagated by the entire surface, magnetic flux is focused on the vicinity of an angular section of the yoke body, and attraction of magnetic force at the portion of the magnetic pole piece Y1 becomes weak. As a result, in a de-energized state, it is necessary to use an expensive stator magnet M such as a high-energy magnet having directivity in a radial direction and possessing a strong magnetic force in order to hold the moveable part K in a stop position at the position of the magnetic pole piece Y2.

When the pole of the magnetic pole piece is excited as shown in FIG. 4A by energizing, the magnetic force of the stator magnet M acts at the magnetic pole piece Y2, magnetic thrust F by the coil C acts at the magnetic pole piece Y3, and two magnetic fields (magnetic flux loop) flowing in respective back reverse directions are produced. Further, it is difficult to focus the magnetic thrust on the magnetic pole piece Y3 because each loop curve changes in accompaniment with movement of the moveable part K Because of this, to pull away the moveable part K magnetized by a strong magnetic force at the magnetic pole piece Y2 in a de-energized state with a magnetic thrust F generated by the energizing current shown in FIG. 4B, and to move the moveable part K to the magnetic pole piece Y3 as shown in FIG. 4C, it is necessary for the magneto motive force of the coil C to be energized with a magnetic force exceeding the strong magnetic force of the stator. It is therefore necessary for the coil space to be large and for there to be a large number of windings on the coil C.

As a result, it is difficult to set the magnetic gap to be large (5 to 30 mm) so as to vibrate a long stroke. This makes making the apparatus compact difficult. Also, an expensive stator magnet M is required. It means that the apparatus itself is large and cannot be make cheaply, and also causes the range of applications to be limited.

In order to provide solutions to the problems described above, the present invention is directed to provide a linear actuator capable of propagating magnetic force of a stator magnet within a yoke in a smooth manner so as to form a superior magnetic path.

Another object is to provide stationary holding in a de-energized state and apply magnetic thrust to the moveable part by excitation efficiently even if the stator magnet does not provide a strong magnetic force. Still another object is to provide a linear actuator capable of providing not just short strokes but also long strokes.

### SUMMARY OF INVENTION

The present invention relates to a linear actuator provided with a moveable part facing a stator magnet provided together with a coil within a yoke, with both magnetic pole pieces of the yoke being exited to an S pole and an N pole respectively by switching of energizing of the coil so as to subject the moveable part to thrust and bring about reciprocal driving. According to the present invention, the coil is divided into split coils so as to retain excitation function, and a magnetic path body for connecting the stator magnet and the yoke is provided between the split coils. Magnetic force of the stator magnet is transmitted to the yoke via the magnetic path body.

The linear actuator of the present invention takes a ferromagnetic as the moveable part and the stator as a permanent magnet, the two being arranged within the yoke together with the coil. It is then possible to form a permanence state where a magnetic path from the stator magnet to the yoke constituting the main route can be formed. Because of this, magnetic force of the stator magnet is magnetically focused on the magnetic path body so that propagation of magnetic force within the yoke is carried out in a smooth manner. Magnetic force of the stator magnet passes through the magnetic path of the side of the majority of the yoke so as to be focused with a strong force as stable, high-density magnetic flux with respect to the magnetic pole pieces of the stop position side of the moveable part in a de-energized state. It is therefore possible for positioning of a moveable part to be firmly maintained even without a particularly large magnetic force.

Together with the adoption of a stator magnet of a small magnetic force, on the side of the magnetic pole piece constituting the stopping position at the time of energizing, coil excitation that easily negates magnetic force by the stator magnet is possible. At the magnetic pole piece constituting the movement side, high-density magnetic flux is focused so as to generate a magnetic flux attraction loop stronger than the magnetic pole piece on the stopping side so as to form magnetic paths apportioning excitation characteristics. It is then possible to achieve movement by providing superior magnetic thrust by excitation force on the moveable part with respective excitation characteristics.

It is therefore possible to adopt a cheap coil as it is not necessary to employ a coil with a large number of windings. It is also no longer necessary to insert a moveable part within a yoke and provide a magnetic pole gap for forming a magnetic force propagation surface as in the related art.

This means not only that the apparatus as a whole can be made compact, but also that energizing control is possible for each coil, and that synchronous energizing, different mode energizing with differing energizing strength and energizing of only one coil etc. can be carried out. It is therefore also possible to reduce the consumed power required to maintain a stop position using excitation and propagation movement of strong magnetic thrust towards the moveable part is possible. It is possible to provide a movement stroke with a long stroke as well as a short stroke in accordance with usage of the actuator.

### BRIEF DESCRIPTION OF THE DRAWINGS

FIG. 1 is a cross-sectional structural view of half of a linear actuator;

FIG. 2 is a view illustrating a circuit for a coil;

FIG. 3A is a view illustrating a magnetic field in a de-energized state;

FIG. 3B is a view illustrating magnetic field and operation during energizing;

FIG. 3C is a view illustrating a magnetic field and operation after energizing; and

FIGS. 4A to 4C are views illustrating operating principle of the related art.

### DETAILED DESCRIPTION OF THE PREFERRED EMBODIMENTS

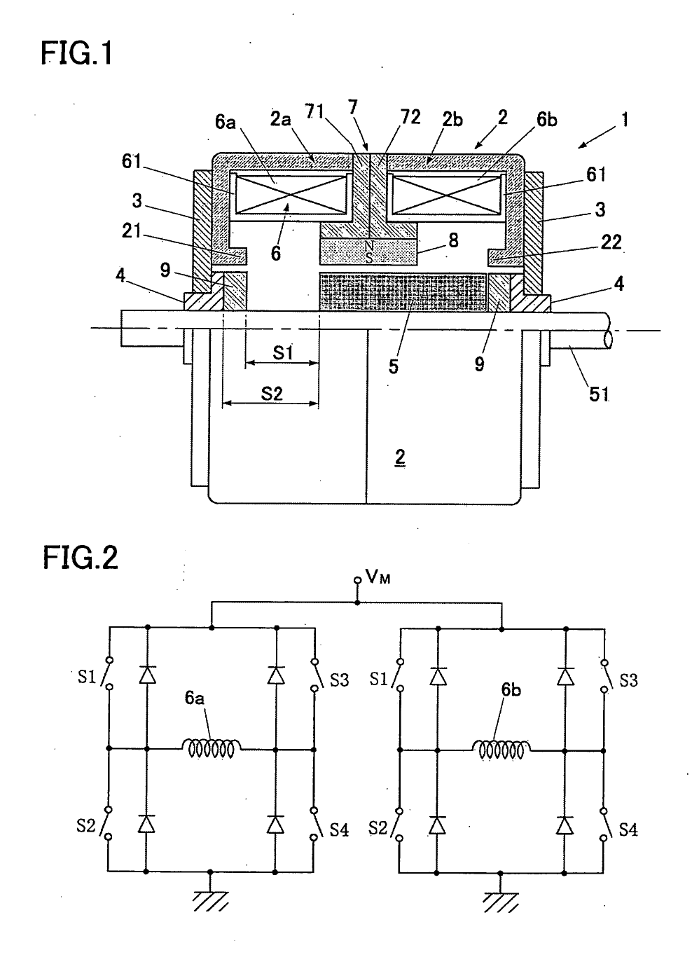

The following is a detailed description based on the drawings of a linear actuator exemplifying a preferred embodiment of the present invention. FIG. 1 is a cross-sectional structural view of half of a linear actuator, and FIG. 2 is a view illustrating a coil circuit. As shown in FIG. 1, a linear actuator 1 is comprised of a yoke 2 made of iron or magnetic stainless steel etc. forming a cylindrical body and magnetic path for the actuator body, a flange 3 arranged to either side of the yoke 2, a bearing 4 provided at the center of flange 3, and a moveable part 5 having a shaft section 51 that is provided at the bearings 4 arranged on both sides of the yoke 2 so as to be moveable in an axial direction. A coil 6 (6a, 6b) wound around a coil bobbin 61 made of resin provided at an inner wall and a stator magnet 8 composed of a permanent magnet provided between the coil 6 and the moveable part 5 are also arranged within the yoke 2.

The coils 6 is provided split symmetrically between the coils 6a and 6b in such a manner as to maintain the excitation function. A magnetic path body 7 connecting the stator magnet 8 and the yoke 2 is provided between the split coils 6a and 6b, and magnetic force of the stator magnet 8 is propagated to the yoke 2 via the magnetic path body 7. The configuration is such that a monofilar winding for bipolar drive use is implemented (single-wound) at the coil 6. Both magnetic pole pieces 21 and 22 are exited to be S and N poles respectively by energizing the split coils 6a and 6b by switching S1 and S2, and S3 and S4 ON and OFF, respectively. Thrust F is then applied to the moveable part 5 to cause reciprocal driving. A split coil 6a or split coil 6b constituting the stop position side only can then be excited according to the necessity of maintaining a stop position. In the drawing, numeral 9 is a stopper for restricting the movement stroke of the moveable part 5, and may be formed from an arbitrary material such as a coil spring, and a block consisting of rubber or resin as necessary.

This is not limited to a two system circuit and may be implemented as a one system circuit where the split coils 6a and 6b are connected in series. A prescribed winding such as a bifilar winding for uni-polar drive use may be adopted.

The yoke 2 is formed in a substantially inwardly-concaved donut-shape, with magnetic pole pieces 21 and 22 formed so as to bend towards the stator magnet 8 in axial directions towards the inside so as to extend in substantially the same plane as the stator magnet 8 at the ends of both sides.

Further, the yoke 2 is formed so as to be split into sub-yokes 2a and 2b by the arrangement of the member for the magnetic path body 7. The magnetic pole pieces 21 and 22 may be formed as a single piece or may be formed as two pieces as a corner section extending down from a side portion of the yoke so as to form a reverse L-shape.

The moveable part 5 is a ferromagnetic body arranged so as not to make contact with the magnetic pole pieces 21 and 22. The width of moveable part 5 is set to a width that is a length that is the sum of the length of the stator magnet 8 in the direction of movement and the opposing space (movement stroke S1) between the magnetic pole piece 21 (magnetic pole piece 22) and stator magnet 8 so that the moveable part 5 is longer than the width of the stator magnet 8. When the moveable body 5 moves to either of magnetic pole pieces 21, 22 at the maximum stroke S2 side, the moveable body 5 spans between the magnetic pole piece 21 (22) and the stator magnet 8. As a result, magnetic fields are formed by excitation of the magnetic pole piece 21 (magnetic pole piece 22) to give an N pole or an S pole through switching of energizing of the coil 6 so as to apply thrust F to the moveable part 5 to bring about reciprocal driving. The extent of this movement can be made to be movement between a variable stroke S1 (5 mm or more) the position of which is restricted in an arbitrary manner by providing a stopper 9 and a maximum stroke S2 (in the order of 30 mm).

The magnetic path body 7 is comprised of a pair of magnetic path members 71 and 72 formed in a ring shape from ferromagnetic bodies such as iron appearing substantially L-shaped in cross-section placed back to back. The overall body is formed with a cross-section appearing as a reverse T-shape with a bottom surface part set to a length covering the opposing surface section of the stator magnet 8. The magnetic path body 7 forms an invariant (fixed) magnetic path at the sides of the split coils 6a and 6b. The magnetic path body 7 has a function for transmitting the magnetic force of the stator magnet 8 to the yoke 2 therethrough, in a de-energized state, when the moveable part 5 is moving towards one of either the magnetic pole piece 21 or the magnetic pole piece 22, and a function of acting as an intermediate yoke magnetic pole piece where the magnetic pole is excited with respect to a surface of the side of the coil 6 of the stator magnet 8 by energizing of the split coils 6a and 6b. Further, the split sub-yokes 2a and 2b are made to be independently symmetrical and can be installed in respective combinations and may also be configured as a member for installing the stator magnet 8. The magnetic path body 7 may also be a single body.

According to the foregoing embodiment of the present invention, a magnetic thrust F is applied to the moveable part 5 to bring about reciprocal driving by exiting the magnetic pole pieces 21 and 22 of the yoke 2 to give N poles and S poles respectively through excitation by forming a magnetic field (magnetic flux loop) by switching of energizing of the coil 6 (6a, 6b). With the linear actuator 1 of the present invention, the magnetic path body 7 linking the stator magnet 8 and the yoke 2 is provided between the split coils 6a and 6b, and magnetic force of the stator magnet 8 is propagated to the yoke via the magnetic path body 7. The yoke 2 does not have to be cylindrical and may be changed to be a planar-recessed shape etc. in an arbitrary manner according to the subject of use. It is simply necessary for the magnetic path body 7 connecting between the stator magnet and the yoke 2 to be provided between the split coils 6a and 6b.

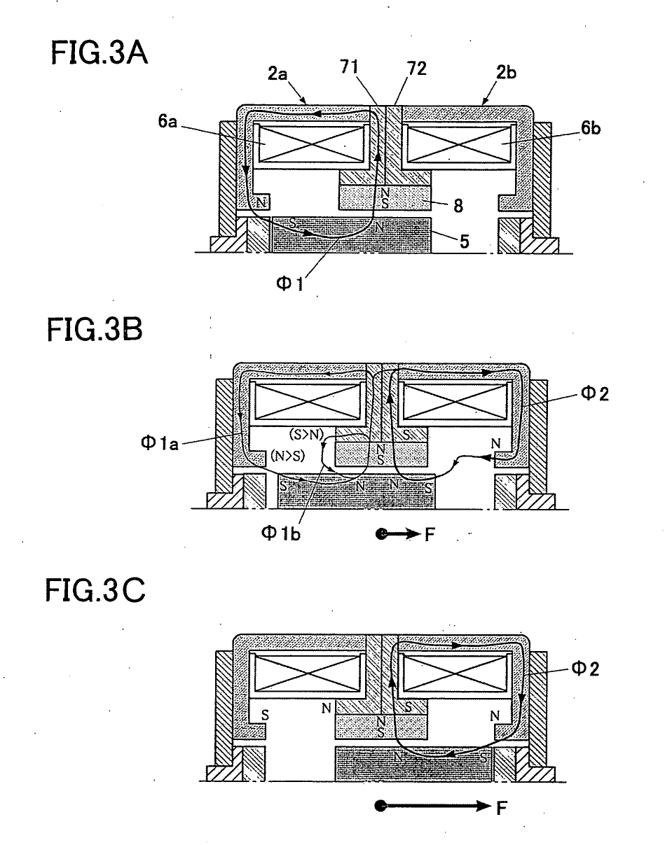

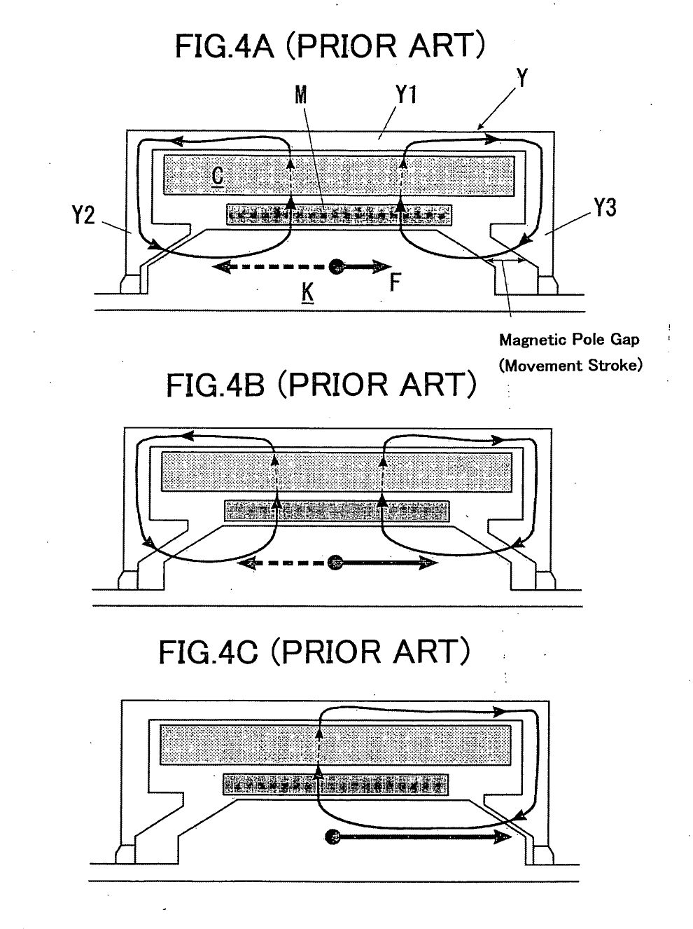

FIG. 3A to FIG. 3C are views illustrating operation based on magnetic loop generation constituting the main part. As shown in FIG. 3A, at the time of no energizing (de-energizing state) where the moveable part 5 is stopped at the side of the magnetic pole piece 21, the magnetic force of the stator magnet 8 flows concentrating on the magnetic path body 7 in a short-circuit state with the yoke 2, and a magnetic loop Φ1 flowing as a main loop is formed only at the side of the sub-yoke 2a defined by the magnetic path body 7. The situation that was encountered in the related art where the coil C becomes a highly magnetic resistance member so that the magnetic force becomes weak, and the magnetic force from the stator magnet M to the yoke Y is dispersed and propagated by the whole surface area so that the magnetic flux is focused in the vicinity of an angular part of the yoke body resulting in magnetic force of attraction becoming weak at the portion for the magnetic pole piece Y1 is therefore resolved. The transmission of magnetic force occurring within the yoke 2 of the stator magnet 8 can therefore be carried out smoothly. As a result, it is possible to focus a high-density magnetic flux on a magnetic pole piece 21 constituting the side of the stop position of the moveable part 5 in the de-energized state. Magnetic propagation can therefore be achieved in an efficient manner without magnetic force declining even with a stator magnet 8 that does not have a particularly strong magnetic force. It is then possible to generate a magnetic flux loop Φ1 stabilized with a strong force along a magnetic path biased to the side of the majority part (sub-yoke 2a) of the yoke 2, and strong positioning can therefore be maintained.

When the coil 6 (6a, 6b) is energized from this de-energized state, an S pole and an N pole are energized at the two poles (magnetic pole piece 21 and magnetic pole piece 22) of the yoke 2, as shown in FIG. 3B. When an S pole is excited at the pole of the magnetic pole piece 21 and an N pole is excited at the pole of the magnetic pole piece 22, at the same time, the magnetic path body 7 functioning as an intermediate yoke becomes an excitation magnetic pole piece with respect to the stator magnet 8. This means that an N pole and an S pole are excited at the opposite back to back sections (magnetic path members 71 and 72). Magnetic flux is then generated in the form of a magnetic flux loop Φ2 at the sub-yoke 2b and excitation force is generated contrary to the flow of the magnetic flux loop Φ1 on the side of the sub-yoke 2a.

In this way, on the side of the sub-yoke 2a constituting the stop position, coil excitation that negates the magnetic force by the stator magnet 8 takes place but the magnetic force of the stator magnet 8 is greater than the excitation force. As “magnetic force>excitation force” is obtained due to cancellation effects, at the magnetic pole piece 21, an “N>S” pole occurs and remains as a magnetic flux loop Φ1 a, and the magnetic path member 71 becomes an “S>N” pole so that a new magnetic flux loop Φ1 b that flows at the center surface of the moveable part 5 directly from the magnetic path member 71 is generated. This magnetic flux loop Φ1 b may be produced by the magnetic force of the stator magnet 8 that is cancelled out by the excitation force but remains and is also prevented from flowing to the magnetic flux loop Φ1 by the excitation force. The magnetic flux loop Φ1 b generated at the central part has virtually no attraction force for self-retaining the moveable part 5 at the sub-yoke 2a side.

On the other hand, the magnetic flux loop Φ2 generated at the sub-yoke 2b constituting the moving side is such that the loop curves do not change in accompaniment with movement of the moveable part 5 because the magnetic flux loop Φ1 and the magnetic flux loop Φ2 cause fixed paths to flow, compared to the related art configuration where the coil C becomes a high magnetic resistance member to the magnetic flux and the magnetic flux become focused on the yoke body. The poles are then excited with respect to the magnetic pole piece 22 and the stator magnet 8 of the magnetic path body 7. It is therefore possible to focus high-density magnetic flux in a state where the magnetic pole portion is always in a stable state using pole generation resulting from this excitation. The strong attraction force due to cooperation of the magnetic force of the stator magnet 8 and the excitation force of the coil 6 is focused on the magnetic pole piece 22 so as to cause operation. The moveable part 5 weakly subjected to the holding magnetic force at the side of the sub-yoke 2a is then pulled away, and a strong initial magnetic thrust F is applied in the direction of the magnetic pole piece 22 to the moveable part 5 to bring about movement.

In this way, when the moveable part 5 subjected to initial thrust exceeds a central point, the magnetic flux loops Φ1 a and Φ1 b substantially disappear, and as shown in FIG. 3C, only the magnetic flux loop Φ2 acts and the strongly attracted moveable part 5 is moved to and stopped at the end of the stroke S2 in such a manner that the thrust becomes zero. In the event that the magnetic flux loop Φ2 that is the main constituent of the stop hold function cannot provide a sufficient stop hold function with just the magnetic force of the stator magnet 8, for example, where holding force is required at the time of valve closing in valve control, or where continuous vibration is not required, it is possible to carry out excitation of the split coil 6b continuously. The power consumption required for excitation can therefore be reduced compared to that of the one coil structure of the related art, use can be carried out according to application and purpose, and this can be utilized in a wide range of applications.

Further, when the energizing direction of the coil 6 is reversed, the magnetic poles exited at the poles of the yoke 2 are reversed. The moveable part 5 is then moved in the reverse direction. As a result of this change in the direction of energizing, the moveable part 5 moves reciprocally in the axial direction. It is then possible to set the movement stroke by making use of the stopper 9 and controlling the energizing current so as to obtain the required vibration.

By adopting a configuration where a moveable part is taken to be a ferromagnet and a stator (stator magnet 8) is taken to be a permanent magnet arranged within the yoke 2 together with the coil 6, at the time of energizing, magnetic force of the stator magnet 8 acts so as to generate opposite magnetic fields. However, the magnetic field route can be formed by assigning respective excitation characteristics to split regions of the sub-yokes 2a and 2b defined by the magnetic path body 7. Together with the adoption of a stator magnet with a small magnetic force, on the side of the magnetic pole piece 21 (22) constituting the stop position, coil excitation that easily cancels out the magnetic force by the stator magnet 8 is possible. At the magnetic pole piece 22 (21) constituting the movement side, where high-density magnetic flux is focused, it is possible to generate attraction of magnetic force that is stronger than the stop side magnetic pole pieces 21 (22). A superior magnetic thrust F is therefore applied by the excitation force with respect to the moveable part 5 based on the respective excitation characteristics.

It is therefore possible to adopt a cheap coil as it is not necessary to employ a coil with a large number of windings. It is also no longer necessary to insert a moveable part within a yoke and provide a magnetic pole gap for forming a magnetic force propagation surface as in the related art. This means not only that the apparatus as a whole can be made compact, but also that energizing control is possible for each split coil 6a and 6b, and that synchronous energizing, different mode energizing with differing energizing strength and energizing of only one coil etc. can be carried out. It is therefore also possible to reduce the consumed power required to maintain a stop position using excitation and propagation movement of strong magnetic thrust towards the moveable part 5 is possible. It is possible to adjust and provide a movement stroke with a long stroke as well as a short stroke in accordance with usage of the actuator.

Further, the magnetic path body 7 is constructed so as to constitute an intermediate yoke formed between the magnetic pole pieces 21 and 22, and is excited together with the magnetic pole pieces 21 and 22 to be prescribed magnetic poles as a result of energizing the coil 6. As a result of this energizing it is possible to energize both of the magnetic pole pieces 21 and 22 and opposite back to back sections (magnetic path members 71 and 72) to become N and S (N, S) poles, so as to form split magnetic paths so as to be assigned between the sides of sub-yokes 2a and 2b. Because of this, on the stop position side, coil excitation that easily cancels out the magnetic force by the stator magnet 8 is possible so as to make self supporting force to the moveable part 5 weak, while it is also possible to focus high-density magnetic flux on the magnetic pole piece 22 (21) constituting the movement side. A stronger attraction magnetic force can be generated at the magnetic pole piece 22 (21) than the stop side magnetic pole 21 (22). Regarding opposite magnetic paths formed as a result of the yoke 2 being defined by the magnetic path body 7, on one side, the magnetic force is negated, while on the other side an optimal thrust is exerted upon the moveable part 5 based on the shared excitation function providing strong attraction of magnetic force.

Further, the magnetic path body 7 can be constructed by splitting the yoke 2 using the members arranged for the magnetic path body 7 and in particular can be constructed using the magnetic path members 71 and 72. One magnetic pole piece side (sub-yoke 2a) and the other magnetic pole piece (sub-yoke 2b) can be assembled back to back with the yoke and may also double as an installation member for the stator magnet 8.

The yoke 2 can therefore be formed symmetrically using the sub-yokes 2a and 2b and parts such as the respective split coils 6a and 6b and the stopper 9 etc. can be assembled. After the stator magnet 8 is installed at the magnetic path member of one of the sub-yokes and the moveable part 5 is inserted, the other sub-yoke may then be brought together to achieve assembly. Compared to the related art disclosed in U.S. Pat. No. 6,028,499 where a fixed stator, like a cover, is provided at both sides of a cylindrical body of a yoke so that the coil C and the stator magnet M are housed internally so as to make an actuator using a fitting member for fitting the fixed stator and stator magnet M, the number of parts and number of assembly steps is reduced, the configuration is simplified, and manufacture is therefore possible using substantially the same processes as the manufacture of a PM-type stepping motor made using a thin iron plate press molding. As a result, it is possible to make this type of actuator, which was difficult to mass produce, precisely. As a result, it is possible to provide a response to requests for the providing of product performance resistant to shocks and vibrations in a configuration where continuous vibrations are caused by a strong reciprocal force driving the moveable part 5, so that it is possible to make a highly precise structure with, for example, typical durability (in the order of 1,000,000 times) for piston driving of an air compressor etc. that is compatible with special durability (approximately 50,000,000 times) such as for pachinko ball launching machines etc.

By adopting the configuration where each split coil 6a and 6b can be energized individually, during synchronous energizing, it is possible to carry out different energizing control to each of the split coils 6a and 6b, to carry out energizing control at offset timings, or to perform control so that only one coil is energized. This makes it possible to shift a strong magnetic thrust F to the moveable part 5 and enables use in pachinko ball firing devices demanding a strong ball impact function on the ball. As foregoing, this brings about the advantages that compatibility can be provided with cases where the magnetic flux loop Φ2 that is the main constituent of the stop function cannot provide a sufficient stop hold function with just the magnetic force of the stator magnet 8, the power consumption required for excitation can be reduced compared with the one coil structure of the related art, and usage according to application and purpose is possible so as to bring about a broad range of application.

Further, by setting the width of the moveable part 5 to be a width that is the sum of the length of the stator magnet 8 in the direction of movement and the movement stroke, the magnetic force is transmitted from the magnetic pole piece 22 (21) to an angular part of the moveable part 5 in the stop position and a strong self-maintaining magnetic field is formed.

The magnetic pole piece 21 (22) may be comprised of two pieces, a magnetic pole piece bent to the inside within substantially the same plane as the fixed magnet 8 and a magnetic pole piece facing the side surface part of the moveable part. An inverted L-shaped magnetic pole piece therefore functions as a corner section. Magnetic flux density is therefore focused on the corner section with respect to the angular section of the moveable part located in the corner section in the stop position of the moveable part 5. This means that propagation of magnetic force with respect to two surfaces centered on the angular section is achieved and that a strong force can be self-sustained. In addition to this, it is also possible to focus magnetic flux density at only the magnetic pole piece facing to the inside with respect to the angular part of the moveable part 5 constituting the moving side so as to transmit an attraction force and apply movement thrust F.

What we claim:

1. A linear actuator provided with a moveable part facing a stator magnet provided together with a coil within a yoke, with both magnetic pole pieces of the yoke being exited to an S pole and an N pole respectively by switching of energizing of the coil so as to subject the moveable part to thrust and bring about reciprocal driving,
wherein:
said coil is divided into split coils so as to retain excitation function, and a magnetic path body for connecting the stator magnet and the yoke is provided between the split coils, such that magnetic force of the stator magnet is transmitted to the yoke via the magnetic path body.

2. The linear actuator of claim 1, wherein the magnetic path body constitutes an intermediate yoke formed between said magnetic pole pieces, and the magnetic path body is exited to become a magnetic pole or poles together with said magnetic pole pieces by energizing the coil.

3. The linear actuator of claim 1, wherein the yoke is split at the location of magnetic path body.

4. The linear actuator of claim 1, wherein the magnetic path body is comprised of two members such that one member is assembled to one magnetic pole piece side of the yoke and the other member is assembled to the other magnetic pole piece side of the yoke.

5. The linear actuator of claim 1, wherein the magnetic path body doubles as a member for installation of the stator magnet.

6. The linear actuator of claim 1, wherein each coil is capable of performing energizing control independently.

7. The linear actuator of claim 1, wherein the moveable part is set to a width that is a length that is the sum of the length of the stator magnet in the direction of movement and the movement stroke.

8. The linear actuator of claim 1, wherein the magnetic pole pieces are comprised of two pieces, one magnetic pole piece is bent to the inside in substantially the same plane as the stator magnet, and another magnetic pole piece faces a side surface part of the moveable part.

9. A linear actuator comprising:
a stator magnet;
a moveable part facing the stator magnet, and said moveable part reciprocally moveable along an axis of movement;
split coils aligned along the axis of movement;
a yoke housing said stator magnet, said moveable part and the coils, and said yoke defining magnetic pole pieces; and
a magnetic path body provided between said splits coils, said magnetic path body connecting the stator magnet and the yoke such that magnetic force of the stator magnet is transmitted to the yoke via the magnetic path body.

10. The linear actuator of claim 9, wherein the magnetic path body constitutes an intermediate yoke formed between said magnetic pole pieces of the yoke, and the magnetic path body is exited to become a magnetic pole or poles together with said magnetic pole pieces by energizing the coil.

11. The linear actuator of claim 9, wherein the yoke is split at the location of magnetic path body.

12. The linear actuator of claim 9, wherein the magnetic path body is comprised of two members such that one member is assembled to one magnetic pole piece side of the yoke and the other member is assembled to the other magnetic pole piece side of the yoke.

14. The linear actuator of claim 9, wherein the magnetic path body doubles as a member for installation of the stator magnet.

15. The linear actuator of claim 9, wherein each coil is capable of performing energizing control independently.

16. The linear actuator of claim 9, wherein the moveable part is set to a width that is a length that is the sum of the length of the stator magnet in the direction of movement and the movement stroke.

17. The linear actuator of claim 9, wherein the magnetic pole pieces are comprised of two pieces, one magnetic pole piece is bent to the inside in substantially the same plane as the stator magnet, and another magnetic pole piece faces a side surface part of the moveable part.
